(19) United States
(12) Patent Application Publication
(10) Pub. No.: US 2025/0132599 A1
(43) Pub. Date: Apr. 24, 2025

(54) ADAPTIVE PROTECTIVE RELAY EVENT REPORTS

(71) Applicant: Schweitzer Engineering Laboratories, Inc., Pullman, WA (US)

(72) Inventors: Normann Fischer, Colfax, WA (US); Douglas I. Taylor, Spokane, WA (US); Ritwik Chowdhury, Charlotte, NC (US)

(73) Assignee: Schweitzer Engineering Laboratories, Inc., Pullman, WA (US)

(21) Appl. No.: 18/490,145

(22) Filed: Oct. 19, 2023

(51) Int. Cl. H02J 13/00; H02H 1/00

(52) U.S. Cl. CPC H02J 13/0004; H02H 1/0061; H02J 13/00001; H02J 13/00002; H02J 13/00034

(57) ABSTRACT

The present application relates to generating adaptive protective relay event reports. In one embodiment, a system comprises a power system response subsystem to monitor electrical parameters in an electric power system and to receive a trigger signal from a trigger source based on identification of an event in an electric power system. An adaptive event report subsystem is configured to generate an adaptive report depending on the trigger related to the event and based on a pre-trigger start, a duration, and a sampling rate. The adaptive event report comprises at least one electrical parameter related to the event beginning at a time established by the pre-trigger start, covering an interval established by the duration, and recorded at the sampling rate.

### TECHNICAL FIELD

The present disclosure relates to systems and methods to generate adaptive protective relay event reports in electric power systems.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a simplified one-line diagram of an electric power system consistent with embodiments of the present disclosure.

FIG. 2 illustrates a simplified block diagram of a system configured to generate an adaptive protective relay event report consistent with embodiments of the present disclosure.

FIG. 3 illustrates a high-level logic diagram of a system configured to generate event reports with an optimal length consistent with embodiments of the present disclosure.

FIG. 4 illustrates a flow chart of a method for generating an adaptive protective relay event report consistent with embodiments of the present disclosure.

In the following description, numerous specific details are provided for a thorough understanding of the various embodiments disclosed herein. However, those skilled in the art will recognize that the systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

Electric power systems are used to generate, transmit, and distribute electric power to loads, and serve as an important part of critical infrastructure. Electric power systems and equipment may be monitored and protected by a variety of types of equipment. Protection relays may analyze the parameters of an electric power system to implement protective functions. The primary protective relays may communicate with various other supervisory devices such as automation systems, monitoring systems, supervisory (SCADA) systems, and other intelligent electronic devices (IEDs). IEDs may collect data from various devices within an electric power system and monitor, control, automate, and/or protect such devices.

As used herein, an IED may refer to any microprocessor-based device that monitors, controls, automates, and/or protects monitored equipment within a system. Such devices may include, for example, differential relays, distance relays, directional relays, feeder relays, overcurrent relays, voltage regulator controls, voltage relays, breaker failure relays, generator relays, motor relays, remote terminal units, automation controllers, bay controllers, meters, recloser controls, communications processors, computing platforms, programmable logic controllers (PLCs), programmable automation controllers, input and output modules, and the like. The term IED may be used to describe an individual IED or a system comprising multiple IEDs. Further, IEDs may include sensors (e.g., voltage transformers, current transformers, contact sensors, status sensors, light sensors, tension sensors, etc.) that provide information about the electric power system.

IEDs may generate event reports that include information about conditions in an electric power system. Event reports may be generated in response to anomalous conditions or other types of events that deviate from established parameters. Such reports may include information that may be used to make the electric power system safer, more reliable, and more economical; however, typical event reports may include a significant amount of information that is unrelated to these objectives. Valuable information may be obscured within large amounts of information, thus requiring significant effort to identify and utilize. The inventors of the present application have recognized that various advantages may be achieved by systems and methods that provide adaptive protective relay event reports. Such adaptive protective relay event reports may be customized to applications and may provide improved access to information while also improving resource utilization involved in creating, storing, and transmitting such reports.

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need to be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Several aspects of the embodiments disclosed herein may be implemented as software modules or components. As used herein, a software module or component may include any type of computer instruction or computer-executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. A module or component may comprise a single instruction or many instructions and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMS, RAMs, EPROMS, EEPROMs, magnetic or optical cards, solid-state memory devices, or other types of media/machine-readable media suitable for storing electronic instructions. In some embodiments, the computer or another electronic device may include a processing device such as a microprocessor, microcontroller, logic circuitry, or the like. The processing device may further include one or more special-purpose processing devices such as an application-specific interface circuit (ASIC), PAL, PLA, PLD, field-programmable gate array (FPGA), or any other customizable or programmable device.

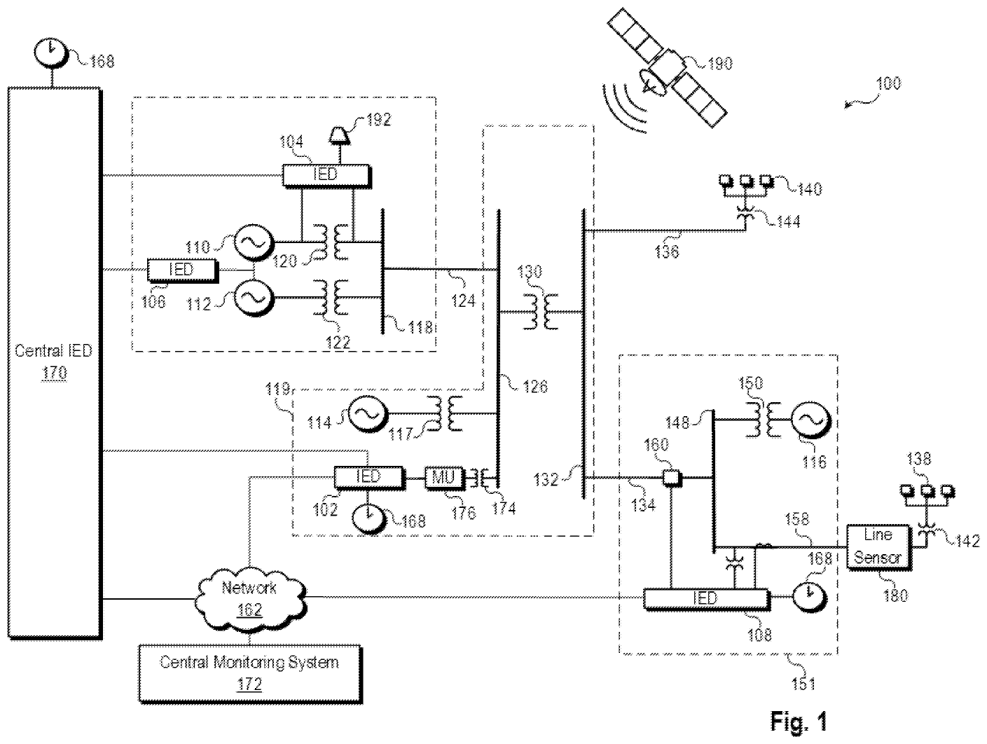

FIG. 1 illustrates a simplified one-line diagram of an electric power system 100 consistent with embodiments of the present disclosure. Electric power system 100 may be configured to generate, transmit, and distribute electric energy to loads. The present disclosure may be utilized in both alternating current electric powers system and direct current power systems. Electric power systems may include equipment such as electrical generators (e.g., generators 110, 112, 114, and 116), transformers (e.g., transformers 117, 120, 122, 130, 142, 144, 150, and 174), power transmission and delivery lines (e.g., lines 124, 134, 136, and 158), circuit breakers (e.g., breaker 160), busses (e.g., busses 118, 126, 132, and 148), loads (e.g., loads 138 and 140) and the like. A variety of other types of equipment may also be included in electric power system 100, such as voltage regulators, capacitor banks, and the like.

Substation 119 may include a generator 114, which may be a distributed generator, and which may be connected to bus 126 through step-up transformer 117. Bus 126 may be connected to a distribution bus 132 via a step-down transformer 130. Distribution lines 136 and 134 may be connected to distribution bus 132. Load 140 may be fed from distribution line 136. Further, step-down transformer 144 in communication with distribution bus 132 via distribution line 136 may be used to step down a voltage for consumption by load 140.

Distribution line 134 may lead to substation 151 and deliver electric power to bus 148. Bus 148 may also receive electric power from distributed generator 116 via transformer 150. Distribution line 158 may deliver electric power from bus 148 to load 138 and may include further step-down transformer 142. Circuit breaker 160 may be used to selectively connect bus 148 to distribution line 134. IED 108 may be used to monitor and/or control circuit breaker 160 as well as distribution line 158.

Electric power system 100 may be monitored, controlled, automated, and/or protected using IEDs, such as IEDs 102, 104, 106, 108, and 170, and a central monitoring system 172. In general, IEDs in an electric power generation and transmission system may be used for protection, control, automation, and/or monitoring of equipment in the system. For example, IEDs may be used to monitor equipment of many types, including electric transmission lines, electric distribution lines, current transformers, busses, switches, circuit breakers, reclosers, transformers, autotransformers, tap changers, voltage regulators, capacitor banks, generators, motors, pumps, compressors, valves, and a variety of other types of monitored equipment.

Central monitoring system 172 may comprise one or more of a variety of types of systems. For example, central monitoring system 172 may include a supervisory control and data acquisition (SCADA) system and/or a wide area control and situational awareness (WACSA) system. A central IED 170 may be in communication with IEDs 102, 104, 106, and 108. IEDs 102, 104, 106, and 108 may be remote from the central IED 170 and may communicate over various media such as a direct communication from IED 106 or over a wide-area communications network 162. According to various embodiments, certain IEDs may be in direct communication with other IEDs (e.g., IED 104 is in direct communication with central IED 170) or may be in communication via a communication network 162 (e.g., IED 108 is in communication with central IED 170 via communication network 162).

A common time signal 168 may be used to time-align measurements for comparison and/or synchronize action across electric power system 100. Utilizing a common or universal time source may allow for the generation of time-synchronized data, such as synchrophasors. In various embodiments, the common time source may comprise a time signal from a GNSS system 190. IED 104 may include a receiver 192 configured to receive the time signal 168 from the GNSS system 190. In various embodiments, IED 106 may be configured to distribute the time signal 168 to other components in electric power system 100, such as IEDs 102, 104, 108 and 170.

A voltage transformer 174 may be in communication with a merging unit (MU) 176. MU 176 may provide information from voltage transformer 174 to IED 102 in a format useable by IED 102. MU 176 may be placed near voltage transformer 174 and may digitize discrete input/output (I/O) signals and analog data, such as voltage measurements. These data may then be streamed to IED 102. In various embodiments, MU 176 may be located outside of a substation enclosure or control house, thus increasing safety by removing high-energy cables from areas where personnel typically work. In various embodiments, MU 176 may be embodied as an SEL-2240 available from Schweitzer Engineering Laboratories of Pullman, Washington.

IEDs 102, 104, 106, and 108 may generate adaptive protective relay event reports. The data and information saved in these reports are valuable for testing, measuring performance, analyzing problems, and identifying deficiencies before they cause future misoperations. The ability to analyze event data quickly and accurately can improve reliability and economic operation of an electric power system. Adaptive protective relay event reports include information about conditions and actions taken by an IED may be analyzed to determine whether the IED operated as expected. Such information may be used to confirm whether components of the protection system were installed and operated correctly. Further, such information may be used to verify power system models, settings, wiring, auxiliary relays, circuit breakers, current and potential transformers, communications equipment, the dc battery system, and connected loads.

IEDs may record and store a great deal of information in a variety of event reports, which may include everything from brief summary messages to oscillograph and phasor data. The analog information in event reports is available in many formats: varying amounts of pre-fault, fault, and post-fault data captured, duration of data capture, number of samples per cycle, and whether the data are digitally filtered. Each format addresses a specific analysis purpose. The systems and methods disclosed herein may be used to tailor the information contained in event reports to the information that is most relevant to particular applications.

A variety of parameters may be used as event report trigger source. Once an event trigger source is detected, an event report may be generated. The event report may be based on a variety of parameters. Such parameters may include a pre-trigger start, a total duration of time, and a sampling rate. The pre-trigger start may specify a period of time preceding the event during which values are recorded in an event report consistent with the present disclosure. The duration of time may specify a period of time during which values are recorded in the event report. The sampling rate may specify the frequency at which the values are sampled. Each of these parameters may be varied based on the application. Some specific examples are listed below.
Time-delayed protection elements can often provide greater sensitivity than elements that trip quickly. To capture the inception of the associated disturbance, event reports with long pre-trigger start (e.g., 10 seconds) can provide useful data, but the data may not need high resolution (e.g., 1 kHz may be adequate).
An instantaneous protection element might benefit from higher sampling rates (e.g., 8 kHz), but the event report may not need to be long. The data before the event report trigger source could be moderate in duration (350 ms), whereas the data post-trigger might be shorter (150 ms).
A breaker close may benefit from short pre-trigger (e.g., 100 ms) but benefit from a relatively long (e.g., 1 second) and high-resolution (e.g., 8 kHz) record.
   The device may be configured with multiple triggers with associated event report parameters to allow capturing an adaptive event report depending on the application.

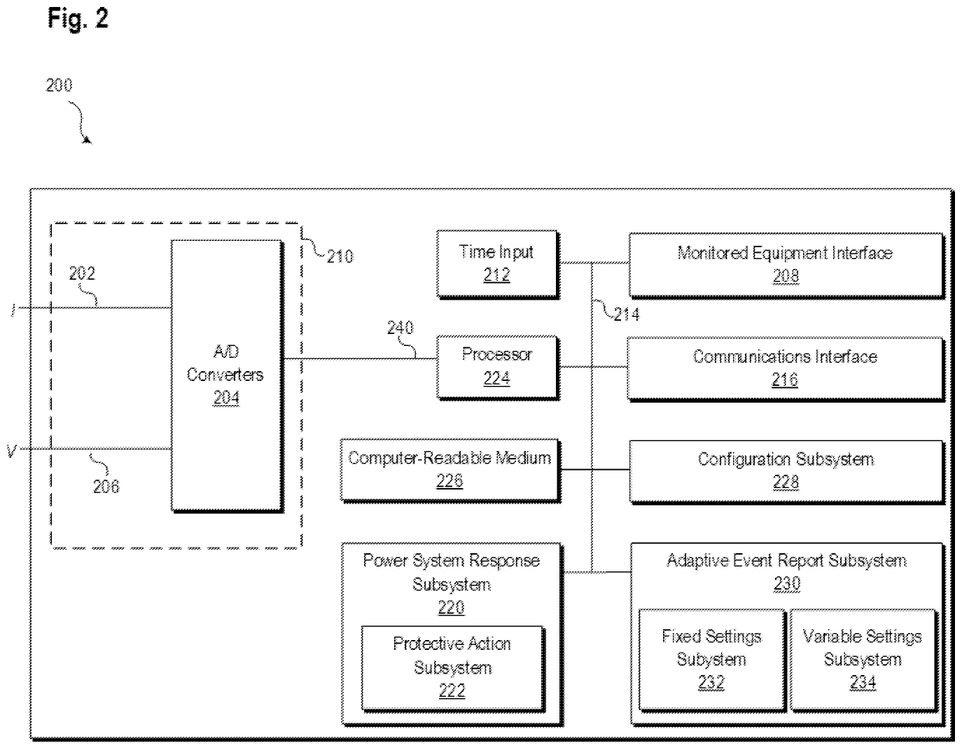

FIG. 2 illustrates a simplified block diagram of a system 200 configured to generate an adaptive protective relay event report consistent with embodiments of the present disclosure. System 200 may be implemented using hardware, software, firmware, and/or any combination thereof. In some embodiments, system 200 may be embodied as an IED, a protective relay, or other type of device. Certain components or functions described herein may be associated with other devices or performed by other devices. The specifically illustrated configuration is merely representative of one embodiment consistent with the present disclosure.

System 200 includes a communications interface 216 to communicate with relays, IEDs, and/or other devices. In certain embodiments, the communications interface 216 may facilitate direct communication or communicate with systems over a communications network (not shown). System 200 may further include a time input 212, which may be used to receive a time signal (e.g., a common time reference) allowing system 200 to apply a time stamp to acquired samples. In certain embodiments, a common time reference may be received via communications interface 216, and accordingly, a separate time input may not be required for time-stamping and/or synchronization operations. One such embodiment may employ the IEEE 1588 protocol. A monitored equipment interface 208 may receive status information from, and issue control instructions or protective actions to monitored equipment (e.g., a circuit breaker, conductor, transformer, or the like).

Processor 224 processes communications received via communications interface 216, time input 212, and/or monitored equipment interface 208. Processor 224 may operate using any number of processing rates and architectures. Processor 224 may perform various algorithms and calculations described herein. Processor 224 may be embodied as a general-purpose integrated circuit, an application-specific integrated circuit, a field-programmable gate array, and/or any other suitable programmable logic device. A data bus 214 may provide connection between various components of system 200. A configuration subsystem 228 may allow an operator to configure various aspects of system 200, including criteria related to thresholds or parameters described above.

Instructions to be executed by processor 224 may be stored in computer-readable medium 226. Computer-readable medium 226 may comprise random access memory (RAM) and non-transitory memory. Computer-readable medium 226 may be the repository of software modules configured to implement the functionality described herein.

System 200 may include a sensor component 210. In the illustrated embodiment, sensor component 210 may receive current measurements 202 and/or voltage measurements 206. The sensor component 210 may comprise A/D converters 204 that sample and/or digitize filtered waveforms to form corresponding digitized current and voltage signals. Current measurements 202 and/or voltage measurements 206 may include separate signals from each phase of a three-phase electric power system. A/D converters 204 may be connected to processor 224 by way of data bus 240, through which digitized representations of current and voltage signals may be transmitted.

Power system response subsystem 220 may monitor conditions and events in an electric power system. The power system response subsystem 220 may receive trigger signals from a trigger sources and determine an appropriate response. In some instances, the response may include triggering a protective action. A protective action subsystem 222 may implement a protective action based on various conditions monitored by system 200. In various embodiments, a protective action may include tripping a breaker to selectively isolate or disconnect a portion of the electric power system, etc. Protective action subsystem 222 may implement a protective action based on identification of a fault condition or other anomalous condition. In other instances, the response may comprise generating an adaptive event report.

An adaptive event report subsystem 230 may be configured to generate an adaptive event report. In some embodiments, adaptive event report subsystem 230 may include default settings for an adaptive event report specified by a manufacturer for specific applications. Table 1 illustrates certain adaptive event report parameters that may be incorporated into some embodiments consistent with the present disclosure.

TABLE 1

| | Pre- | Event | |
|---|---|---|---|
| | Trigger | Report | Event Report |
| | Start | Duration | Sampling |
| Application | (Seconds) | (Seconds) | Rate (kHz) |
| Instantaneous generator differential | 0.35 | 0.50 | 8 |
| protection trip (87G) or split-phase | | | |
| differential protection trip (87SP) | | | |
| Time-delayed overcurrent (51T01) | 9.5 | 10 | 1 |
| or backup distance Zone 2 trip | | | |
| (21Z2T) | | | |
| Ground Fault Trip (64GT) | 2 | 2.5 | 4 |
| Breaker Close | 0.1 | 1 | 8 |
| Breaker Open | 0.2 | 0.4 | 8 |
| Loss-of-Potential (VT Fuse | 2 | 2.5 | 4 |
| Failure) or CT Failure Alarms | | | |

A user may adjust the default settings to customize adaptive protective relay event reports provided by system 200 using configuration subsystem 228. For instance, a user may modify parameters of an adaptive event report based on the nameplate rating of a device (e.g., a large generator versus a small generator) or based on an operator's preferences (e.g., a preference for 0.5 kHz for a time-delay overcurrent relay element but prefer 10 KHz for a breaker close operation); requirements (e.g., regulatory mandates); or other conditions (e.g., age of monitored equipment).

In some embodiments, adaptive event reports consistent with the present disclosure may also be associated with a priority parameter. When the event storage has been used, event reports with a lower priority may be deleted first. In still other embodiments, system 200 may monitor whether an event report has been retrieved from the relay. If a particular event report has not been retrieved, the report may be given priority over reports that have been retrieved and are therefore more likely to be retained.

A fixed settings subsystem 232 may comprise a plurality of settings associated with an adaptive protective relay event report. In some embodiments, fixed settings subsystem 232 may include a pre-trigger start, an event report duration, a sampling rate, and other parameters related to information included in an adaptive event report. In some embodiments, fixed settings subsystem 232 may also comprise default settings. Users may elect to accept the default settings or to adjust the default settings.

A variable settings subsystem 234 may be configured to provide event reports with optimal event report length and sampling rate depending on the nature of the disturbance. Variable settings subsystem 234 may dynamically determine a pre-trigger start, the duration, and the sampling rate based electrical parameters monitored by system 200. Variable settings subsystem 234 may be configured to utilize the different analog quantities and/or digital quantities to dynamically determine event report parameters. For instance, when there is a transient that might correspond to the trigger condition (e.g., based on the output of a disturbance detector), analog signals (e.g., voltage and current measurements) may be analyzed to determine an appropriate sampling rate. For fast transients, the event report could have a higher sampling rate; for slow transients, the event could have a slower sampling rate; and for no transients, the event report could have the slowest sampling rate. In some embodiments, the sampling rate may vary over an interval encompassed by an event report. For example, when a disturbance occurs, the event report can have a high sampling rate to capture additional detail. As the disturbance subsides, the sampling rate may be reduced. The lower sampling rate may facilitate capturing additional post-event information without a significant increase in the size of the adaptive report.

In some embodiments, the relay determines event report parameters based on digital quantities (e.g., overcurrent pickup, swing pickup, excessive DC harmonics, external fault detector, protection trip, etc.). Once relevant analog and digital signals enter a steady state, variable settings subsystem 234 may terminate the event report and make the report available for retrieval.

Some embodiments consistent with the present disclosure may generate variable length event reports. Variable length event reports may be useful for elements that have long operating times, have timed out, and possibly require low sampling rates. The following example illustrates certain applications based on the following settings, in which descriptions are provided following the number (#) symbol.
PCT51PU: =0 #No input pickup time
PCT51DO: =0.1 #Dropout timer in seconds
PCT51IN: =51S01 OR 51S02 OR 51S03 #Pickup of any time-overcurrent element
ER2=/51S01 OR/51S02 OR/51S03 #Time-delayed overcurrent pickup acting as event report trigger source
PRE2=0.5 seconds #Pre-trigger start
LER2=10 seconds #Duration
SRATE2=1 kHz #Sampling Rate
ER_STOP2=/51T01 OR/51T01 OR/51T03 OR \PCT51Q #Time-delayed 51 trip or 51 element dropped out 0.1 seconds earlier and acting as an event report stop signal
POST2=0.5 seconds

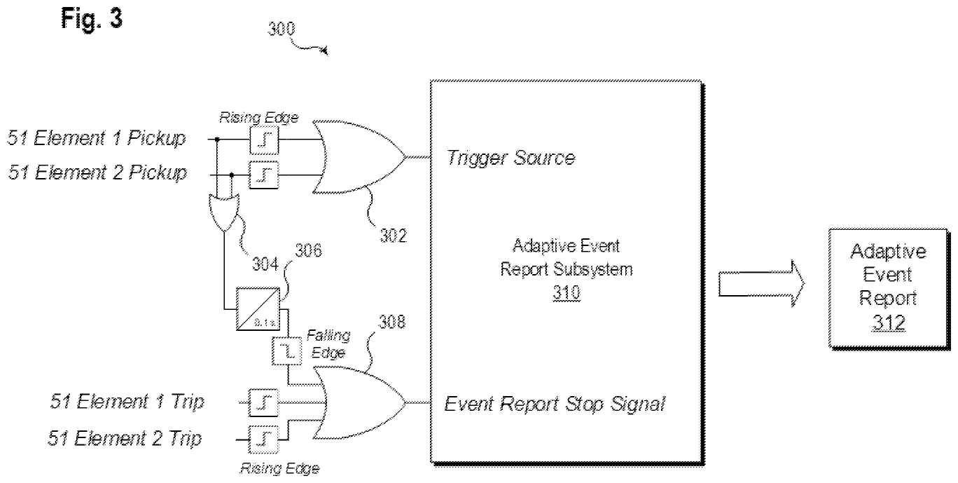

FIG. 3 illustrates a high-level logic diagram of a system 300 configured to generate event reports with an optimal length consistent with embodiments of the present disclosure. System 300 relates to an inverse-time overcurrent relay (ANSI device number 51), but one of skill in the art will recognize that the principles described herein are applicable to a variety of devices. The 51 element may include two pickups that are inputs to OR gate 302. Assertion of the input signals causes OR gate 302 to assert an ERn (event report trigger source) signal.

The ERn signal may provide a trigger for generation of an adaptive event report. Based on the assertion of the ERn signal, an adaptive event report subsystem 310 may create an adaptive event report. Providing a trigger source for generating an adaptive event report may allow users to implement adaptive event reporting based on a variety of criteria and suited for various applications.

The pickups associated with the 51 element may also be inputs to OR gate 304. Assertion of one or both pickup signals may cause OR gate 304 to assert an output signal. The output of OR gate 304 may activate a timer 306. In the illustrated embodiment, timer 306 may implement a drop-out delay of 0.1 seconds so the output of the timer remains asserted for 0.1 seconds after the input of the timer deasserts.

The 51 element may also include two trip signals that are inputs to OR gate 308. The trip signals may be activated upon implementation of a protective action (e.g., a trip signal). The output of OR gate 308 may generate an ER_STOPn (event report stop) signal. The implementation of a trip signal may provide a trigger for terminating an event report.

Adaptive event report subsystem 310 may receive output signals from OR gate 302 and OR gate 306 and generate an adaptive event report 312. Adaptive event report subsystem 310 may store parameters related to adaptive event report 312, such as a pre-event trigger start, a maximum event report duration, a sampling rate, and a post-event duration. Using these parameters, adaptive event report subsystem 310 may optimize the length of adaptive event report 312. Several examples are described below.

In a first case, a 51S01 element asserts at t=0 seconds, remains asserted, and a 51T01 element asserts at 5 seconds. Based on settings specified by a user, an event report may include data from t=−0.5 seconds to t=+5.5 seconds (i.e., a total of 6 seconds) and measured at 1 KHz. The start-time corresponds to the assertion of the trigger source minus pre-trigger start. The end-time corresponds to the event report stop signal plus a post-event time.

In a second case, the 51S01 element asserts at t=0 seconds and drops out at 0.050 seconds. In that case PCT51Q will drop out at 0.150 seconds. The total event report capture duration would be t=−0.5 seconds to t=+0.650 seconds (i.e., a total of 1.15 seconds) at 1 KHz. The early termination of event recording can save device storage.

In a third case, the 51S01 element asserts at t=0 seconds and the 51T01 element asserts at 20 seconds. The event report captures 10 seconds of data from t=−0.5 seconds to +9.5 seconds because the maximum event report duration, as determined by the LERn parameter is 10 seconds. The data associated with the trip may be configured with a separate ERn based on the trip signal. In some embodiments, event report stop signal and the post-event duration are optional parameters. If the event report stop signal does not trigger within the event report duration, then the event report may correspond to the maximum event report duration.

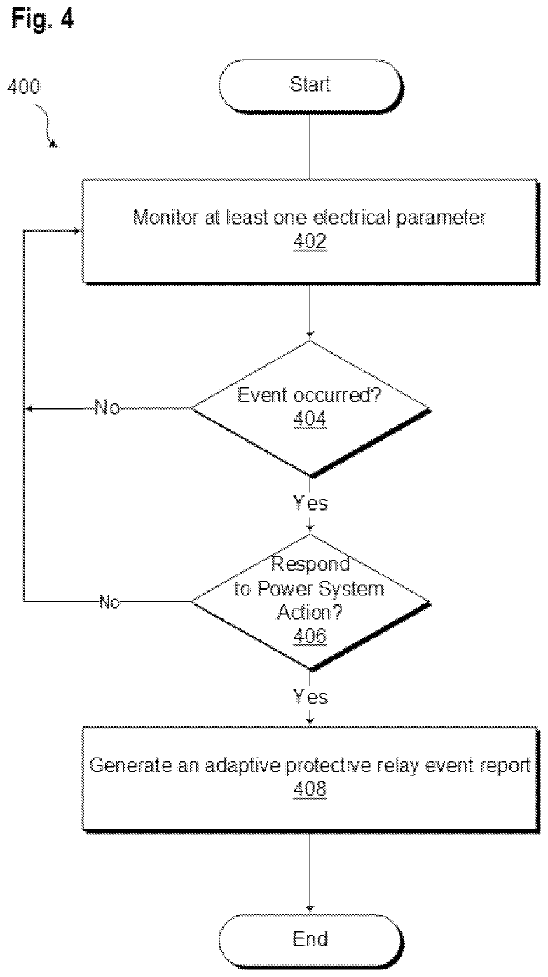

FIG. 4 illustrates a flow chart of a method 400 for generating an adaptive protective relay event report consistent with embodiments of the present disclosure. In one specific embodiment, system 200, illustrated in FIG. 2, may implement method 400.

At 402, at least one electrical parameter in an electric power system may be monitored. The electrical parameter may comprise measurements of voltages, currents, phases, and a variety of other types of signals. In some embodiments, digital signals may also be monitored. Such monitoring may be performed by IEDs, protective relays, or a variety of other types of equipment.

At 404, it may be determined whether an event has occurred. An event may include a fault or other condition. The determination of the occurrence of the event may be based on at least one monitored electrical parameter. If an event has not occurred, method 400 may return to 402 and continue to monitor the at least one electrical parameter.

At 406, once an event has occurred, it may be determined whether to respond to a power system event. A response to a power system event may include various actions. In some instances, a response may include implementing a protective action. A protective action may include a variety of actions (e.g., opening a breaker to selectively disconnect a portion of an electric power system, closing a breaker to restore a portion of an electric power system, increasing power generation, decreasing power consumption, changing a tap of voltage transformer, producing an alarm, trigger a maintenance indication, etc.). In other instances, a response may be to generate a record of an action in an adaptive protective relay event report. If a no response is necessary, method 400 may return to 402 and continue to monitor the at least one electrical parameter.

At 408, an adaptive protective relay event report may be generated. The adaptive protective relay event report may include at least one electrical parameter related to the event, may begin at a time established by the pre-trigger start, may cover an interval established by the variable duration, and may be recorded at the sampling rate. In some embodiments, a user may specify the pre-trigger start, the duration, and the sampling rate. In other embodiments, the pre-trigger start, the duration, and the sampling rate may be dynamically determined. A rate of change of monitored electrical parameters may be used to determine the pre-trigger start, the variable duration, and the sampling rate based on a rate of change of one or more electrical parameters related to the event. Alternatively or in addition, digital quantities may be used to establish the pre-trigger start, the duration, and the sampling rate. Various embodiments may dynamically determine the pre-trigger start, the variable duration, and the sampling rate without user intervention. Maximum and/or minimum values may be established by an operator for one or all of the pre-trigger start, the duration, and the sampling rate.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed:

1. A system configured to generate an adaptive protective relay event report, the system comprising:
a power system response subsystem to:
monitor at least one electrical parameter in an electric power system; and
receive a trigger signal from a trigger source; and
an adaptive event report subsystem configured to generate an adaptive protective relay event report comprising a measure of at least one electrical parameter related to the event and based on:
the trigger source;
a pre-trigger start;
a duration; and
a sampling rate;
wherein the adaptive protective relay event report comprises the measure of the at least one electrical parameter related to the event beginning at a time established by the pre-trigger start and an event report trigger source, covering an interval established by the duration, and recorded at the sampling rate.

2. The system of claim 1, wherein the adaptive event report subsystem is configured to receive user input comprising the pre-trigger start, the duration, and the sampling rate.

3. The system of claim 1, further comprising a fixed settings subsystem to receive and store the pre-trigger start, the duration, and the sampling rate.

4. The system of claim 1, further comprising a variable settings subsystem configured to dynamically determine the pre-trigger start, the duration, and the sampling rate.

5. The system of claim 4, wherein the variable settings subsystem is further configured to dynamically determine the pre-trigger start, the duration, and the sampling rate based on a rate of change of the at least one electrical parameter related to the event.

6. The system of claim 5, wherein the variable settings subsystem is further configured to dynamically determine the pre-trigger start, the duration, and the sampling rate based on the rate of change of the at least one electrical parameter related to the event without user intervention.

7. The system of claim 4, wherein the variable settings subsystem is further configured to establish a minimum value and a maximum value for at least one of the pre-trigger start, the duration, and the sampling rate.

8. The system of claim 4, wherein the variable settings subsystem is further configured to dynamically determine the pre-trigger start, the duration, and the sampling rate based on a value of a digital quantity related to the event.

9. The system of claim 1, wherein the adaptive protective relay event report comprises a priority designation.

10. The system of claim 1, wherein the adaptive event report subsystem is further configured to terminate the adaptive protective relay event report prior to the duration based on a dropout of the measure of at least one electrical parameter.

11. The system of claim 1, wherein the power system response subsystem further comprises a protective action subsystem configured to generate a protective action in response to the trigger signal.

12. A method of generating an adaptive protective relay event report, the method comprising:
monitoring, using a power system response subsystem, at least one electrical parameter in an electric power system;
identifying, using a power system response subsystem, an event based on the at least one electrical parameter; and
generating, using an adaptive event report subsystem, an adaptive protective relay event report comprising at least one electrical parameter related to the event and based on:
a pre-trigger start;
a duration; and
a sampling rate;
wherein the adaptive protective relay event report comprises at least one electrical parameter related to the event beginning at a time established by the pre-trigger start and an event trigger source, covering an interval established by the duration, and recorded at the sampling rate.

13. The method of claim 12, further comprising receiving, using the adaptive event report subsystem, user input comprising the pre-trigger start, the duration, and the sampling rate.

14. The method of claim 12, further comprising receiving and storing, using a fixed settings subsystem, the pre-trigger start, the duration, and the sampling rate.

15. The method of claim 12, dynamically determining, using a variable settings subsystem, the pre-trigger start, the duration, and the sampling rate.

16. The method of claim 15, further comprising dynamically determining, using the variable settings subsystem, the pre-trigger start, the duration, and the sampling rate based on a rate of change of the at least one electrical parameter related to the event.

17. The method of claim 16, further comprising, dynamically determining, using the variable settings subsystem, the pre-trigger start, the duration, and the sampling rate based on the rate of change of the at least one electrical parameter related to the event without user intervention.

18. The method of claim 15, further comprising establishing, using the variable settings subsystem, a minimum value and a maximum value for at least one of the pre-trigger start, the duration, and the sampling rate.

19. The method of claim 15, further comprising dynamically determining, using variable settings subsystem, the pre-trigger start, the duration, and the sampling rate based on a value of digital quantity related to the event.

20. The method of claim 12, wherein the adaptive protective relay event report comprises a priority designation.

21. The method of claim 12, further comprising terminating, using the adaptive event report subsystem, the adaptive protective relay event report prior to the duration based on a dropout of the at least one electrical parameter.

22. The method of claim 12, further comprising implementing a protective action based on identification of the event.
